(19) United States
(12) Patent Application Publication
(10) Pub. No.: US 2021/0129378 A1
(43) Pub. Date: May 6, 2021

(54) SYSTEMS AND METHODS FOR MANUFACTURE OF FIBER CEMENT PANELS HAVING OMNIDIRECTIONAL DRAINAGE PLANE

(71) Applicant: Norwood Architecture, Inc., Louisville, CO (US)

(72) Inventors: Steven Norwood, Louisville, CO (US); Bruno Demey, Summerville, SC (US)

(21) Appl. No.: 17/259,167

(22) PCT Filed: Jul. 8, 2019
(86) PCT No.: PCT/US19/40856

§ 371 Date: Jan. 9, 2021

Related U.S. Application Data
(60) Provisional application No. 62/695,574, filed on Jul. 9, 2018.
(60) Provisional application No. 62/806,658, filed on Feb. 15, 2019.

(51) Int. Cl. B28B 1/52; E04C 5/07

(52) U.S. Cl. CPC B28B 1/527; E04C 2/06; E04C 5/073

(57) ABSTRACT

Methods and systems for form an omnidirectional drainage plane integral to a surface of a fiber cement panel. A felt belt used in a Hatscheck process for forming the fiber cement panel includes a belt adaptation that imprints a panel adaptation on the felt surface of the fiber cement panel. The belt adaptation may span the entire felt belt, or may be configured only on a portion, or portions, thereof.

### CROSS-REFERENCE TO RELATED APPLICATIONS

This application claims priority to U.S. Provisional Patent Application Ser. No. 62/695,574, filed Jul. 9, 2018, and U.S. Provisional Patent Application Ser. No. 62/806,658, filed Feb. 15, 2019. Each of the aforementioned applications are incorporated by reference in their entirety herein.

This application is also related to U.S. Pat. No. 9,963,887 B2, which is incorporated by reference in its entirety herein.

### BACKGROUND

There are multiple manufacturing methods and techniques that have been developed for the production of fiber cement products. For example, Durock®, and PermaBase® are manufactured using an extrusion technique.

One of the methods of producing fiber cement cladding products is the ‘Hatschek process’ invented by Ludwig Hatschek in 1901. This process, and derivatives of it, is still in use today. For example, a basic diagram of the machinery and process used is included as FIG. 1, which is FIG. 1 of U.S. Patent Application Publication No. 2007/0215230A1 to Pemegger et al. U.S. Patent Application Publication No. 2007/0215230A1 is incorporated by reference herein.

In the Hatschek process fiber cement panels are produced by a process where thin films of fiber cement are built up one upon another until a full thickness sheet is achieved. As shown in FIG. 1, the Hatschek process is implemented on a system 10 that includes vats 12 of fiber cement slurry. A rotating sieve 16 within the vat 12 picks up a thin film of fiber and cement on the surface of the sieve 16 as the sieve 16 rotates in the vat 12 of slurry 14 that is agitated in the vats 12 via agitators 13. A moving felt belt 30 is passed over the sieve 16 and a film of fiber cement material is picked up and transferred to the moving, porous, endless felt belt 30. The amount of slurry 14 deposited on the felt belt 30 by each cylinder 16 is controlled by a corresponding couch roll 18. As the felt belt 30 rotates about the system as it is driven by guide rollers 20, the felt belt 30 serves as a drainage medium reducing the water content of the fiber cement which may be encouraged by suction boxes 26. The fiber cement film is transferred to and deposited onto a rotating drum, or forming roller 22, until a sheet of fiber cement material is built up on the forming roller 22 to the desired thickness. As the forming roller 22 rotates against the moving felt belt 30, the fiber cement material is compressed and further dewatered as it passes between the forming roller 22 and the felt belt 30 at the drive roller 24 (also referred to as a “Breast roller”). The pressure between the forming roller 22 and the felt belt 30 at the drive roller 24 presses the films together to form a sheet 28 of fiber cement material on the forming roller 22.

When the desired thickness of material is obtained on the forming roller 22, the fiber cement is cut free (represented by arrow 40 in FIG. 1) of the forming roller 22. Once produced, a curing process occurs such that a variety of curing, autoclaving or other processes are employed to complete the manufacture of the fiber cement sheet.

The efficiency of this process has ensured its continued use over time. However, the process has inherent limitations in its ability to produce smooth surfaces, patterns or specific textures on both sides of the fiber cement sheets. Smooth surfaces and patterns, such as simulated wood grain, are currently produced by utilizing a smooth or patterned forming roller 22. This forming roller 22 will create a smooth or patterned surface (when the forming roller 22 itself is textured) on the upper side or face of the fiber cement sheet. This upper side of the fiber cement sheet is referred to herein as the “roller surface”, the surface formed by the forming roller 22. The opposite side of the fiber cement sheet will receive a texture that is imprinted by the texture of the felt belt 30 (referred to herein as the “felt surface”).

The manufacturers of fiber cement have sought to reduce the marred, irregular texture imprinted by the felt on the felt surface of the fiber cement boards. This is primarily due to the curing and autoclaving process where the sheets are stacked. In the process of stacking, the irregular felt surface of one sheet is in contact with the upper roller surface of the sheet immediately adjacent and below. The irregular felt surface texture can transfer to the surface of adjacent sheets, marring the intended exposed roller surface of the adjacent boards on which they are stacked. To address this problem, felt manufacturers continue to develop ever smoother felts to reduce this undesirable transfer of texture from the felt surface of one board to roller the next in the autoclaving or curing process. The heaviest texture felt of known use today in the industry utilizes a felt with a texture of less than 1.0 mm.

Fiber cement products are hygroscopic in nature. Concerns have been raised in the cladding industry regarding the tendency of fiber cement and other cement based claddings to retain water, increasing the risk of damage and degradation to underlying house wraps, building papers, gypsum sheathings, wood based sheathings, and wood framing.

### BRIEF DESCRIPTION OF THE FIGURES

The foregoing and other features and advantages of the disclosure will be apparent from the more particular description of the embodiments, as illustrated in the accompanying drawings, in which like reference characters refer to the same parts throughout the different figures. The drawings are not necessarily to scale, emphasis instead being placed upon illustrating the principles of the disclosure.

FIG. 1 depicts a block diagram of the Hatscheck process used to form fiber cement panels.

FIG. 2 depicts a portion of a system used for manufacture of a fiber cement panel using an adapted felt belt, in embodiments.

FIG. 3 depicts an adapted felt belt, which is an example of the adapted felt belt of FIG. 2, in an embodiment.

FIG. 4 depicts a cross-section of the adapted felt belt along section line A-A′.

FIG. 5 depicts an adapted felt belt, which is an example of the adapted felt belt of FIG. 2, in an embodiment.

FIG. 6 depicts a cross-section of the adapted felt belt along section line B-B′.

FIG. 7 depicts an example of the felt surface side of a fiber cement panel formed using adapted felt belt.

FIG. 8 shows an adapted felt belt having a grid of first portions and second portions.

FIG. 9 depicts a method of manufacturing a fiber cement panel having integral omnidirectional drainage plane, in an embodiment.

FIG. 10 depicts a method of manufacturing a fiber cement panel having integral omnidirectional drainage plane, in an embodiment.

FIG. 11 depicts a method of manufacturing a fiber cement panel having integral omnidirectional drainage plane, in an embodiment.

### DETAILED DESCRIPTION OF THE EMBODIMENTS

To improve the performance of fiber cement claddings, embodiments herein reduce the area of direct contact between the back side of the fiber cement-based cladding and the underlying surface on which the fiber cement-based cladding is mounted. This reduction reduces the capillarity of the cladding and improves the cladding's ability to dry without transferring water into the underlying construction.

Embodiments herein disclose a system and method for manufacture of patterned or textured fiber cement sheets utilizing uniquely patterned and/or coarse textured felts, and the associated products formed thereby, and associated felts used in the method of manufacture. The unique depth of patterned and textured felts disclosed in the embodiments herein, when used in the typical Hatschek fiber cement manufacturing process and its derivatives, provide a novel method of imprinting texture and pattern on felt side of fiber cement sheets. The fiber cement sheets, manufactured in this method, can be used as exterior cladding where the pattern or texture is of sufficient depth to reduce the capillarity between the cladding product and the surface on which it is mounted.

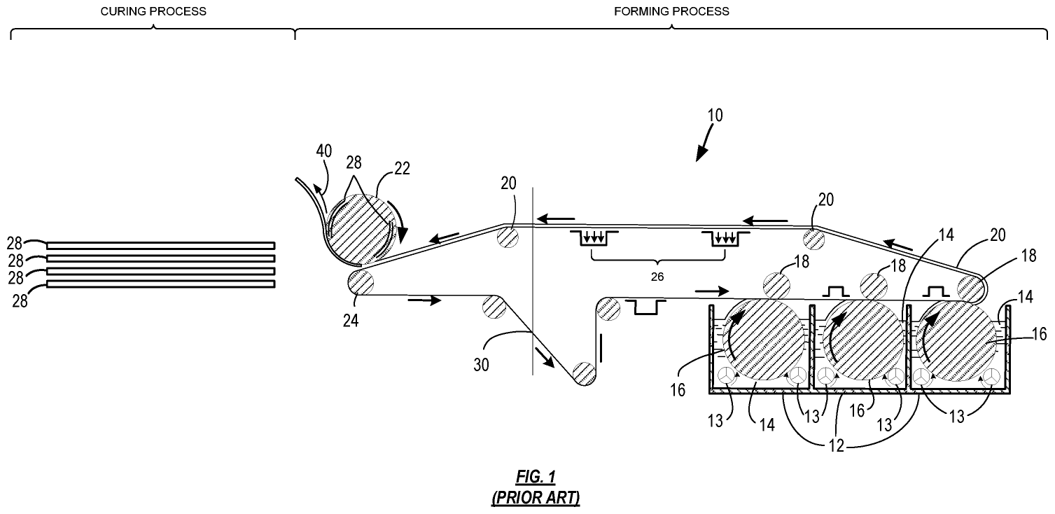

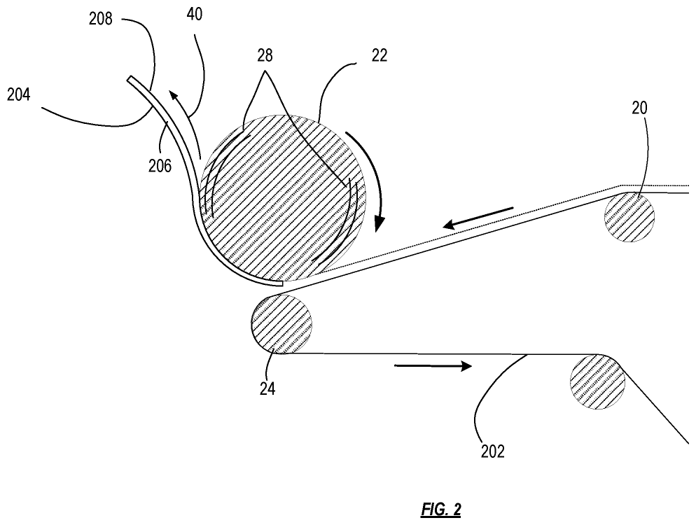

FIG. 2 depicts a portion of a system 200 used for manufacture of a fiber cement panel using an adapted felt belt 202, in embodiments. System 200 is similar to system 10, and is showing the forming roller 22, breast roller 24, drive roller 20, discussed above with respect to FIG. 1. Aspects of FIG. 1 that are not shown in FIG. 2 are included in the system 200. However, instead of felt belt 31, discussed above, system 200 includes the adapted felt belt 202. The adapted felt belt 202 is one or more of patterned, coarse, textured, and any combination thereof in order to purposefully create a pattern on the felt surface 204 of the fiber cement panel 206 created thereby.

The adapted felt belt 202, as used in the above discussed Hatscheck process, continuously transfers a fiber cement slurry 14 from the sieve 16 to the forming roller 22. The adapted felt belt 202 imprints a pattern or texture on the a felt surface 204 of the fiber cement panel sheet 206 as it is formed on the forming roller 24 or as it leaves the forming roller 24. This pattern or texture on the felt surface 204 is the surface of the fiber cement panel placed against the wall surface on which the fiber cement panel is mounted after cutting of the green fiber cement panel sheet 206 from the forming roller 24 and hardening (e.g., curing, autoclaving, air curing, and/or carbonating) the green fiber cement panel sheet 206. The green fiber cement panel sheet 206, after cutting from the forming roller 24 and curing, includes two surfaces, the felt surface 204 imprinted by the adapted felt belt 202 placed and place against the wall surface, and the roller surface 208, which is the outer surface of the fiber cement panel when mounted on the wall. This method allows for the fiber cement cladding to be produced with an inner surface imprinted by the felt and an exterior surface (e.g., the roller surface 208) formed by the forming roller 24 such that the exterior surface is smooth or patterned corresponding to the surface of the forming roller 24.

“Fiber cement panel” as discussed herein include any one or more of cladding, siding, sheathing, trim board, and other fiber cement panels. Furthermore, the fiber cement panels manufactured according to any of the embodiments herein may be mounted in any orientation, such as felt surface exterior or felt surface interior.

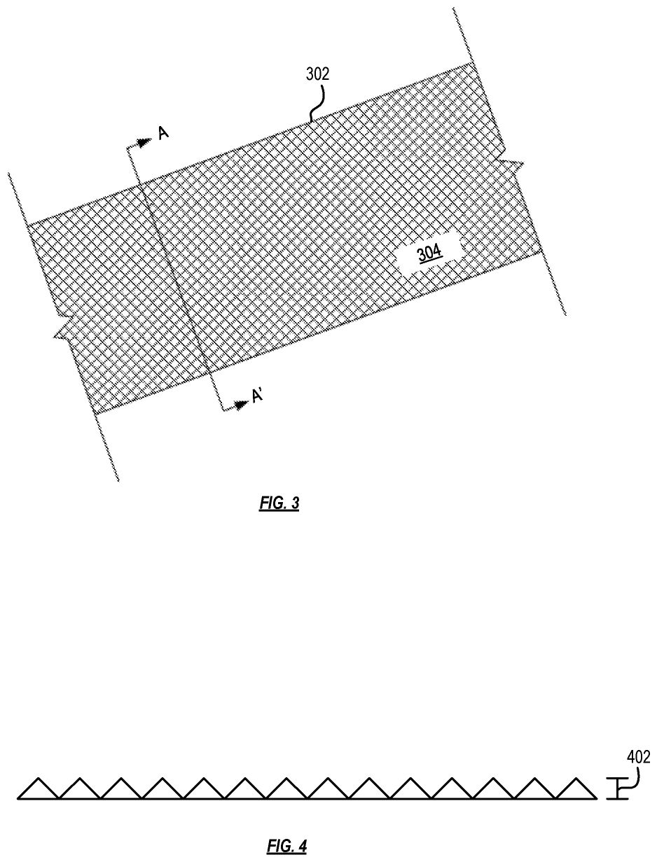

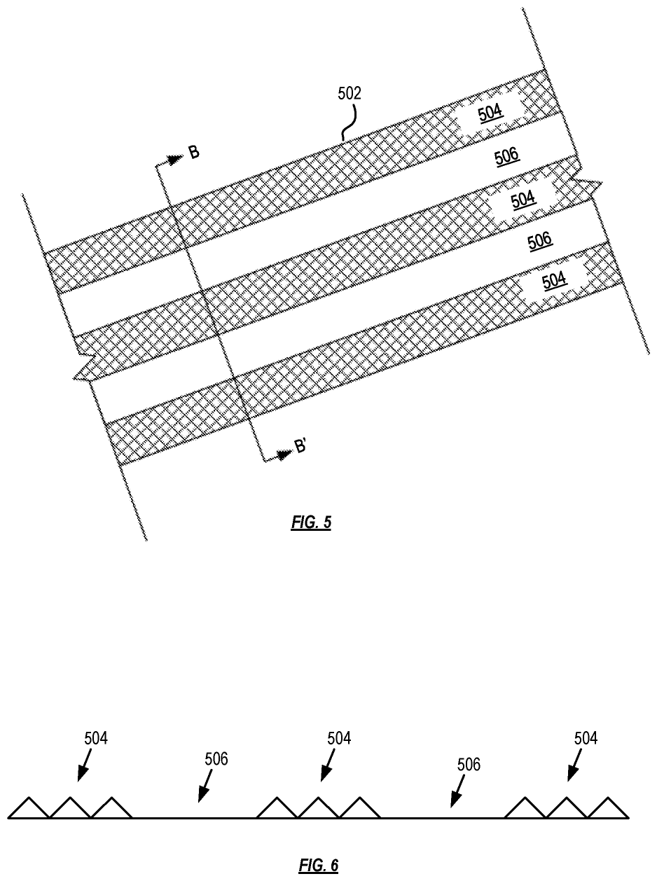

FIG. 3 depicts an adapted felt belt 302, which is an example of the adapted felt belt 202 of FIG. 2, in an embodiment. FIG. 4 depicts a cross-section of the adapted felt belt 302 along section line A-A′. FIGS. 3 and 4 are best viewed together with the following description. The adapted felt belt 302 includes at least one side 302 thereof adapted with a pattern, texture, roughness, coarseness, or combination thereof (individually or collectively referred to as a “belt adaptation” herein) of roughly 1.0 mm or greater in total difference in dimension from the highest to lowest point (delta 402). This belt adaptation and delta 402 is configured to produce a texture or pattern of roughly 0.5 mm in felt surface (e.g., felt surface 204) of the fiber cement cladding formed by system 200. Thus, in embodiments, the adapted felt belt 303, having delta 404 that is greater than typically used in the industry are used during the manufacture of fiber cement panels.

In embodiments herein, the belt adaptation of greater than 1.0 mm produces a pattern or texture (e.g., a “panel adaptation”) on the felt surface 206 of the fiber cement panel with a depth or delta of greater than 0.5 mm. Thus, in embodiments discussed herein, the panel adaptation of high and low spots or areas and/or rough texture imprinted by a modified, or overly textured patterned felt belt 202 reduces the area of direct contact between the fiber cement cladding product formed using the patterned felt belt 202 and the surface on which it is mounted.

In another embodiment, the adapted felt belts discussed herein will produce a pattern or texture of indentations in the felt surface 204 of the fiber cement sheet 206. In another embodiment, the adapted felt belts discussed herein will produce a pattern or texture of raised bumps of the felt surface 204 of the fiber cement sheet 206.

In another embodiment, the unique patterned and texture felt will produce a pattern or texture of raised bumps or indentations, or a combination of both, on all or a portion of the fiber cement sheet. Cladding boards or panels cut from the fiber cement sheets may have patterns or textures over the entire surface, or just a portion of the surface of the boards or panels.

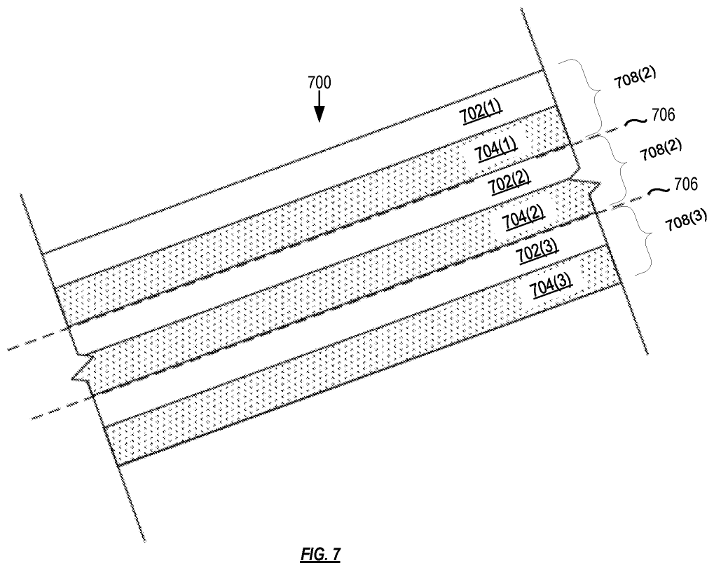

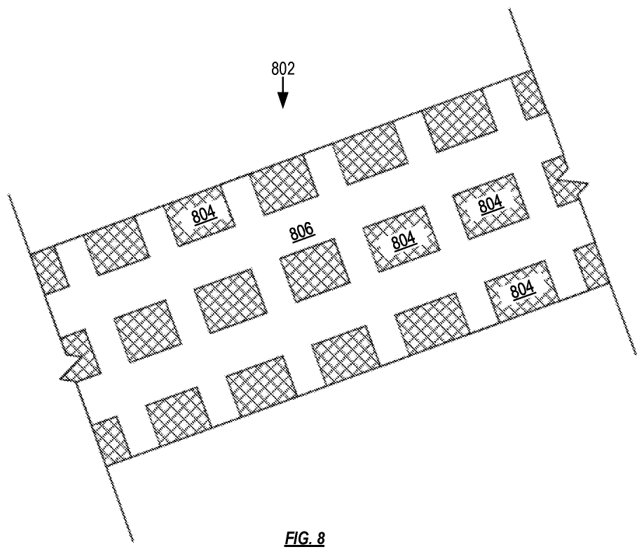

FIG. 5 depicts an adapted felt belt 502, which is an example of the adapted felt belt 202 of FIG. 2, in an embodiment. FIG. 6 depicts a cross-section of the adapted felt belt 302 along section line B-B′. FIG. 7 depicts an example fiber cement panel 700 formed using adapted felt belt 502. FIGS. 5-7 are best viewed together with the following description. The adapted felt belt 502 includes a plurality of sections along the along the longitudinal axis 503 of the adapted felt belt 502. The plurality of sections may include first portions 504 that include the above discussed belt adaptation (e.g., adapted with a pattern, texture, roughness, coarseness, or combination thereof). The plurality of sections further include second portions 506 that are “smooth”, not patterned, and/or otherwise non-textured. The first portions 504 may be interspersed between the second portions 506. In embodiments, the first portions 504 have the above discussed dimensions of adaptation forming depth 404.

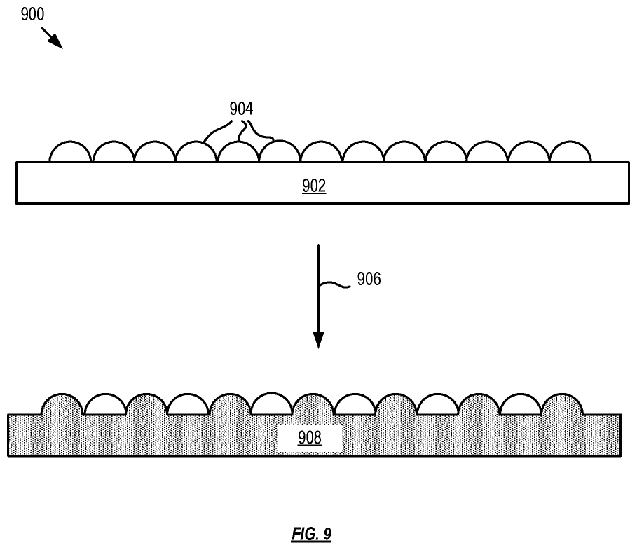

The first and second portions 504, 506 may be strips as shown in FIG. 5. While the above discussed portions 504 and 506 are shown having similar dimensions (e.g., widths) any varying dimensions may be used herein without departing from the scope hereof. Moreover, the portions 504 and 506 may not be lateral rectangular “strips”, but may instead be waves, curves, or any other shape. For example, FIG. 8 shows an adapted felt belt 802 having a grid of first portions 802 and second portions 804. The first portions 802 include the above discussed belt adaptation (e.g., adapted with a pattern, texture, roughness, coarseness, or combination thereof). The second portions 804 are “smooth”, not patterned, and/or otherwise non-textured.

Adapted felt belt 502 (and adapted felt belt 802) allows the manufactured fiber cement panel 700 to have first portions 702 that are that are not patterned or textured, and second portions 704 patterned or textured. Each pair (or more) of the portions 702 and 704 may be cut along the longitudinal axis of the fiber cement panel 700 at cut lines 706 to form individual cladding panels 708, such as a siding panel, trim board, etc. The first portions 702 may have a first depth that is less than a second depth of the second portions 704 caused by the belt adaptation of the felt belt used to manufacture said panel 700. As such, the second strips 506 of the adapted felt belt 502 may be similar to the felts currently produced while the first strips 504 of the adapted felt belt 502 having a greater belt adaptation in the felts resulting in fiber cement sheets with areas of greater or lesser texture or pattern.

Additional/Alternative Modifications to Standard Fiber Cement Manufacturing Process

The above embodiments discuss creating a fiber cement panel using an adapted felt belt. However, alternate, or additional modifications to standard fiber cement manufacturing processes could be used to create the fiber cement panel having omnidirectional drainage plane. These modifications could be made between the forming process and curing process, or as modifications to the curing process, of either system shown in FIG. 1 or 2. For example, in one embodiment, the pattern or texture to be formed on the ‘Felt surface’ (e.g., the surface of the sheet 28 in FIG. 1 that is not touching the form roller 22, but instead touching the felt belt 30; or felt surface 204 in FIG. 2) is augmented or formed after the cement sheet leaves the initial sheet formation process (e.g., after cutting 40 of the sheet after formation on the form roller 22). The formation or augmentation of the pattern or texture can occur either prior to or after autoclaving, air curing, or carbonation of the fiber cement sheets. Fiber cement that has not hardened, cured, carbonized, or been autoclaved is referred to herein as ‘green’. This additional method is applicable to, but not limited to, the Hatschek and Flow-on fiber cement manufacturing process as well as others such as extrusion fiber cement formation techniques.

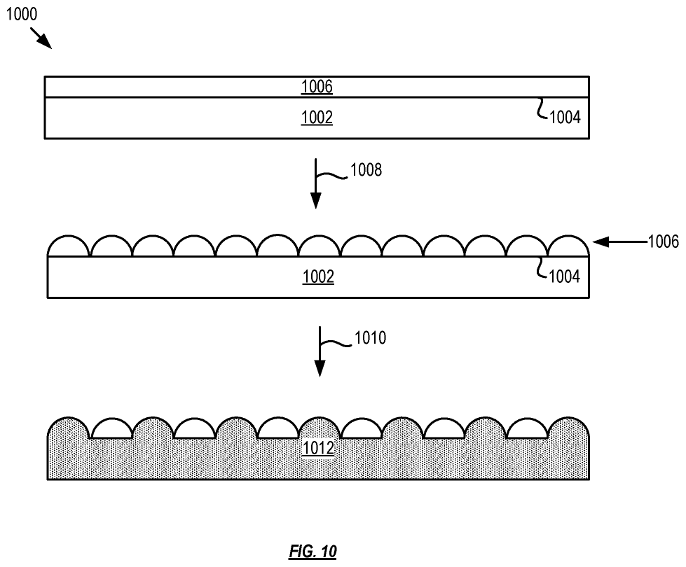

FIG. 9 depicts a method 900 of manufacturing a fiber cement panel having integral omnidirectional drainage plane, in an embodiment. As shown in FIG. 9, after a fiber cement panel 902 (e.g., either of the fiber cement panels of FIG. 1 or 2) is formed to a desired thickness, additional fiber cement material 904 is added to the sheets in a texture or pattern either by deposition, spray, transfer, mold, additive manufacturing, or other additive method to build a pattern on the on the surface of the fiber cement sheet. Subsequent to the deposition of additional fiber cement material, of the same material as the fiber cement sheet, the sheet 902 with its pattern of additional material 904 is hardened, autoclaved, cured, crystalized, or carbonated (as represented by arrow 906) to produce a one-piece homogeneous board 908 of fiber cement that includes a texture or pattern, such as but not limited to the pattern as reflected in U.S. Pat. No. 9,963,887.

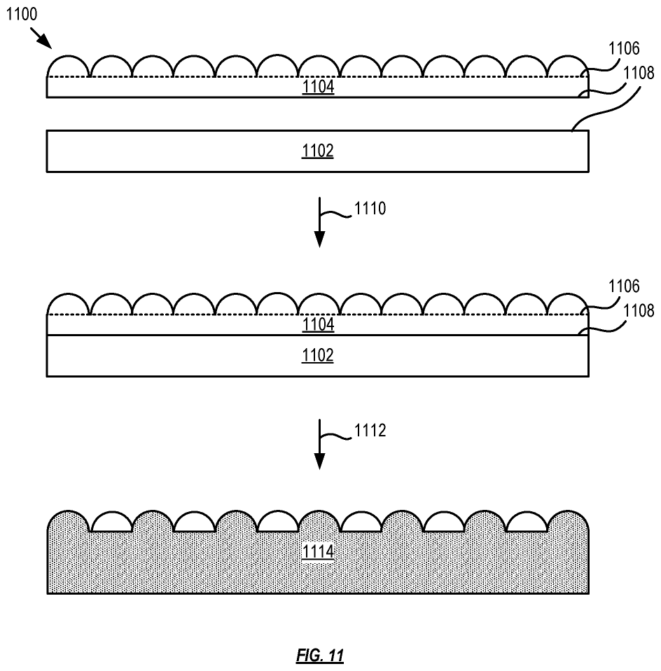

FIG. 10 depicts a method 1000 of manufacturing a fiber cement panel having integral omnidirectional drainage plane, in an embodiment. In method 1000 a layer of fiber cement material 1006 is added of consistent depth to the felt surface 1004 of the initial green fiber cement panel 1002 prior to curing. After the added layer, a pattern or texture is formed (represented by arrow 1008) by the removal of material within the layer 1006 while the added fiber cement material is in its green state and has not hardened, autoclaved, cured, crystalized, or carbonated. Removal may be performed by cutting with tools or by water jet spray. After the pattern has been formed in the added layer, the fiber cement sheet and the patterned layer is hardened, autoclaved, cured, crystalized, or carbonated (as represented by arrow 1010) to produce a one-piece homogeneous board of fiber cement 1012 that includes a texture or pattern integral to the back surface thereof as discussed in U.S. Pat. No. 9,963,887 thereby creating the omnidirectional drainage plane discussed therein. This results in a cumulative panel that has an integral texture, pattern, of raised and/or lowered elements forming an omnidirectional drainage plane.

FIG. 11 depicts a method 1100 of manufacturing a fiber cement panel having integral omnidirectional drainage plane, in an embodiment. In addition to an initial, green, fiber cement panel 1102, a second green fiber cement panel 1104 is formed with the pattern or texture formed on the roller surface 1106 (such as via the forming roller 22 having a complimentary pattern to the desired pattern on the finished product that is imprinted onto the green fiber cement panel during the formation discussed above with respect to FIG. 1. In this embodiment, the felt surface 1108 of the two fiber cement sheets does not receive a specific pattern or texture. Prior to hardening, autoclaving, curing, crystalizing, or carbonating and while in their green states, the two fiber cement sheets are bonded together (as indicated by arrow 1110) The second sheet may include perforations and indentations or raised features. The two sheets are bonded together on their felt surfaces 1108. The two sheets may or may not be bonded by a slurry of fiber cement, or may be bonded by pressure. After the two sheets are bonded in their un-cured, green state, the two sheets now one and are hardened, autoclaved, cured, crystalized, or carbonated (as indicated by arrow 1112) to produce one single piece homogeneous sheet 1114 of fiber cement where one face of the sheet includes a texture or pattern forming the omnidirectional drainage plane as discussed in U.S. Pat. No. 9,963,887.

In another embodiment, while the initial fiber cement panel 202 is in its green state, a pattern or texture is formed in the sheet surface by the removal of material by cutting grinding, water jet spray, or similar method. After the pattern is formed, the sheet is hardened, autoclaved, cured, crystalized, or carbonated to produce one single piece homogeneous sheet of fiber cement where one face of the sheet includes a texture or pattern as discussed in U.S. Pat. No. 9,963,887.

In another embodiment, while the initial fiber cement panel generated in FIG. 1 or FIG. 2 is in its green state, a pattern or texture is formed in the sheet surface by passing the green fiber cement sheet between opposing rollers after the fiber cement panel 202 has been cut from the forming roller 24. One of the opposing rollers has a desired decorative pattern, and another has a pattern complimentary to the desired omnidirectional drainage plane pattern. After the pattern is formed, the sheet is hardened, autoclaved, cured, crystalized, or carbonated to produce one single piece homogeneous sheet of fiber cement where one face of the sheet includes a texture or pattern as discussed in U.S. Pat. No. 9,963,887.

In another embodiment, a separate fiber cement grid, of the same material as the green fiber cement panel is bonded or otherwise attached to the green fiber cement panel. The separate fiber cement grid may be hardened, autoclaved, cured, crystalized or carbonated at the same time or prior to bonding or attachment to the green fiber cement panel. In another modification to this embodiment, the green fiber cement panel 202 has already been hardened, autoclaved, cured, crystalized, or carbonated prior to bonding or attachment with the separate fiber cement grid. The separate fiber cement grid may form the omnidirectional drainage plane discussed in U.S. Pat. No. 9,963,887.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for manufacturing a fiber cement panel having omnidirectional drainage plane, comprising:
continuously transferring a fiber cement slurry from a slurry source to a forming roller using an adapted felt belt to imprint a panel adaptation on a felt surface of a fiber cement panel being created on the forming roller; and
cutting the fiber cement panel from the forming roller when the fiber cement panel achieves a desired thickness.

2. The method of claim 1, further comprising hardening the cut fiber cement panel.

3. The method of claim 1, the forming roller having a smooth or decorative pattern thereon that imprints to a roller surface of the fiber cement panel during the continuously transferring the fiber cement slurry.

4. The method of claim 1, the adapted felt belt having a belt adaptation of greater than 1.0 mm.

5. The method of claim 1, the adapted felt belt having a belt adaptation such that the panel adaptation on the felt surface of the fiber cement panel is greater than 0.5 mm.

6. The method of claim 1, the adapted felt belt having first portions including a belt adaptation, and second portions without the belt adaptation.

7. The method of claim 6, the first portions and second portions being strips along the longitudinal axis of the adapted felt belt.

8. The method of claim 7, further comprising cutting the fiber cement panel along cutting lines to form fiber cement siding panels each having a first panel portion having the panel adaptation that forms the omnidirectional drainage plane and a second portion without the panel adaptation.

9. The method of claim 6, the first portions being configured in a grid.

10. An adapted felt belt for use in a Hatscheck process to form a fiber cement panel, comprising:
a belt adaptation configured to imprint a panel adaptation on the felt surface of the fiber cement panel.

11. The adapted felt belt of claim 10, the belt adaptation having a depth of greater than 1.0 mm.

12. The adapted felt belt of claim 10, the belt adaptation configured to imprint the panel adaptation on the felt surface of the fiber cement panel having a depth greater than 0.5 mm.

13. The adapted felt belt of claim 10, the adapted felt belt including first portions having the belt adaptation and second portions not having the belt adaptation.

14. The adapted felt belt of claim 13, the first portions and the second portions being strips.

15. The adapted felt belt of claim 14, each of the strips having equal dimensions.

16. The adapted felt belt of claim 14, each of the strips having varying dimensions.

17. The adapted felt belt of claim 13, the first portions being configured in a grid.

18. The adapted felt belt of claim 13, the first portions being configured in a wave or curve shape.
